(19) United States
(12) Patent Application Publication
(10) Pub. No.: US 2002/0009299 A1
(43) Pub. Date: Jan. 24, 2002

(54) System for the display of stereoscopic photographs

(76) Inventor: Lenny Lipton, Greenbrae, CA (US)

Correspondence Address: Richard A. Nebb, Dergosits & Noah LLP, Four Embarcadero Center, Suite 1150, San Francisco, CA, 94111, US

(21) Appl. No.: 09/729,503

(22) Filed: Dec. 4, 2000

Related U.S. Application Data
(60) Provisional application No. 60/169,046, filed on Dec. 4, 1999.

(51) Int. Cl. G03B 11/00; H04N 13/02

(52) U.S. Cl. 396/324; 396/544; 348/49

(57) ABSTRACT

A stereoscopic photography system utilizes digital camera technology to create stereoscopic content. The camera has a photosensitive material optically aligned with a lens for capturing images, a viewfinder screen for viewing the images captured on the photosensitive material, and a zoom control for adjusting the focal length of the lens. An optical attachment is securely coupled to the camera lens in a manner that permits adjustment. The optical attachment causes a stereo pair of images to be focused through the lens onto the photosensitive material The camera is coupled to a processor having a first program for digitizing the stereo pair of images and a second program for transforming the digitized stereo pair of images into a predefined format. The transformed images are displayed on a monitor and observed through either a modulating overlay screen or modulating eyewear.

### BACKGROUND OF THE INVENTION

Since the invention of stereoscopic photography, inventors have sought a way to simplify the process and to make it more appealing to the general public. There have been two basic trends in this direction. On the one hand, there have been efforts to devise an apparatus having two cameras built into a single camera body, with separate lenses having the capability of photographing the left and right views on two separate areas of the same roll of film. On the other hand, there have been efforts to use an ordinary planar camera, but with the addition of some kind of an optical attachment. When this optical attachment is added to an existing camera lens, i.e., one originally designed for planar photography, it is converted into a lens for taking stereoscopic pictures. The are many examples of such prior art in the patent literature, including the thirty-five U.S. Patents listed on Appendix A.

The optical attachment photographs two images of the same subject from two perspective viewpoints, and places this stereo-pair of images adjacent to each other on the film. Some of patents listed in Appendix A describe devices for converting still cameras into stereoscopic cameras and others describe devices for converting motion picture cameras into stereoscopic cameras. Still and motion picture devices can be of a similar design, but some of the motion picture devices are meant to record left and right images on successive frames of film—a process which cannot be easily used for still photography. It is noted that these examples of the background art were all written in the context that the imaging means is based on silver photographic film.

In the present disclosure, we are concerned with the use of an optical attachment to produce a stereo-pair of images with an existing digital still camera. More specifically, we are concerned with an attachment that works in conjunction with an ordinary lens—one not meant for the taking of stereoscopic images.

As is well known, there are cameras that have interchangeable lenses and cameras that have fixed lenses. This distinction is made because in the past products have been offered for cameras with interchangeable lenses which were a dual-lens device, such as that described in U.S. Pat. No. 2,724,311. This device was designed for Leica cameras and used two objective lenses and a reflecting system to create the necessary interaxial separation. However, this approach will only work with a camera using interchangeable lenses. In the present disclosure we are concerned with optical attachments that use reflective means to capture a stereo-pair from two perspective viewpoints. These attachments work in conjunction with a lens meant for planar photography, whether or not it is of the interchangeable type.

There are two well-known means for viewing the results of this kind of photography. One is by projection and the other is by viewing with a stereoscope. Photographers using this medium have preferred a transparency material, which is better suited for projection and also viewing in a lenticular stereoscope.

The particular format produced by an attachment may create a design challenge when it comes to crafting a stereoscope. There are a number of different format possibilities, as illustrated in FIG. 2, and a viewing device designed for one will not work with another. Moreover, the particular attachment design, while it may have advantages for photography, may necessitate an optically complex and costly stereoscope.

The stereo-pairs created by such attachments may produce any one of several different formats as shown in FIGS. 2A-2F. Attachments produce formats made up of two sub-frames, which are apportioned from the existing frame. For example, in FIG. 2A we see images formatted into side-by-side sub-frames, with the resultant vertical or “portrait” aspect ratio. By way of example, the teachings of U.S. Pat. Nos. 2,314,174, and 2,362,790 allow one to produce this format. In FIGS. 2A-2E, we see that the images have been rotated so that the resultant image has what is referred to as a “landscape” aspect ratio. The arrangement of the images in FIGS. 2B and 2C is essentially identical except that they are rotated 180 degrees. FIG. 2C is what is sometimes referred to as the “tail-to-tail” format, and in FIG. 2D a “head-to-head” format. By way of example, the landscape aspect ratio is produced by several of the devices listed in Appendix A, such as U.S. Pat. Nos. 2,282,947, 2,313,561, and 2,693,128.

These different formats are incompatible in terms of projection lens and stereoscope design. Projection lens optics or stereoscopes must be designed for each of the particular formats shown in FIG. 2 so that a photographer taking pictures with one camera attachment may not be able to show these images on equipment designed for other attachments because of the lack of standardization. Also, care has to be given to making sure that there is compatibility within a system; the means for viewing the stereo-pairs must be compatible with the attachment design. In some cases the stereoscope design becomes elaborate and costly.

There was a great deal of activity in stereoscopy for snapshots and as a means of personal expression in the 1940s and '50s. The introduction of the Stereo-Realist camera in the late '40s in the United States was instrumental in piquing the public's interest and the fad continued for a decade afterwards The interest in this medium extended to many segments of the population. There is a famous photograph of Dwight Eisenhower holding a Stereo-Realist camera, and Hollywood movie stars belonged to a stereo photography club.

The need to view the images with a stereoscope may well have been the most daunting aspect of the medium, for viewing an image this way is an isolating experience. There is something about a photograph that is heightened when viewed by a group. Moreover, changing slides is cumbersome.

In addition, projection of stereoscopic slides is a difficult procedure. It requires a darkened room, a special so-called “silver screen” with a metallic-coated reflecting surface required, and even more importantly, a great deal of care must be taken in the setting up and alignment of the projector. Truly, it is a job for an expert.

In FIG. 1, we see a prior art attachment based on the Wheatstone or mirror stereoscope. It produces the portrait format shown in FIG. 2A. Wheatstone announced the discovery of his stereoscope in 1838, and the design has been applied to camera attachments thereafter, because optical systems are reversible and his design is simple. In this case we see light-sensitive surface 107 and camera 106 with lens 105, with some mounting means (such as a retaining ring meant for filters or a focal converters) 104, for the stereoscopic lens attachment, 101. The attachment itself, 101, is made up of outer reflecting surfaces 103A and 103B and inner reflecting surfaces 102A and 102B. This optically simple device produces two images on the image-sensitive surface 107. I have selected this particular attachment from amongst several for illustrative and didactic purposes. Many of the other devices described in the patents in the table above could have been selected, but they are optically more complicated.

One significant problem with regard to using this attachment in particular, and any such attachment, is that it must be properly aligned to the camera and with respect to the film aperture. If the attachment is skewed, i.e., not properly aligned to the vertical (or horizontal), then the two sub-frames will be misaligned with respect to each other, and there will be resultant vertical parallax. Vertical parallax does not contribute to the perception of a stereoscopic image, but rather induces discomfort upon viewing. Moreover, if the attachment is skewed the boundary between the two sub-frames will not be aligned to the edge of the frame's aperture or edge, which reduces the useful imaging area and this also becomes aesthetically distracting.

Aligning such a device must be done with care, and this is difficult to achieve when using a camera with an optical rather than a reflex viewfinder. The user might have to take trial pictures and examine the slides before assuring himself or herself that the results are acceptable.

There is no point in describing other known camera attachments since the basic idea may be grasped by looking at FIG. 1, which produces a format of the kind shown in FIG. 2A. The improvement in the formats shown in FIGS. 2A-2F is that a more pleasing landscape aspect will be achieved. In the case of 2F, this format resembles the above-and-below motion picture format used in the theatrical film industry, but for most purposes the aspect ratio is extreme. A long and narrow landscape format is typically pleasing for all but a minority of compositions. Such a format is achieved by horizontally bisecting the frame, whereas all the other formats vertically bisect the frame. In the case of FIG. 2A, no image rotation is provided, but for all of the others except FIG. 2F, rotation is required to achieve the desired landscape aspect ratio.

Stereoscopic attachments have been less successful in the marketplace than cameras with a dual-lens design such as the Stereo-Realist camera. The major raison d'étre for these attachments, that they allow for the use of an existing camera, providing convenience while saving the user the purchase price of a new camera, is less important than the disadvantages noted above

Therefore, it is the object the present invention to overcome the prior art drawbacks that have inhibited the commercialization of stereoscopic photography in general and in particular when the art involves an attachment for a planar camera/lens. The major drawbacks have been that the attachments are difficult to properly align; that there is a lack of standardization amongst the various formats produced by such attachments so that images viewed with one may not be viewed with equipment designed for another; that the design of the attachment itself may lead to costly and cumbersome display means; that it is difficult to correct for mistakes of a stereoscopic nature made during photography; and finally, that the viewing of such images, most commonly done with a stereoscope, is an individual rather than a group experience. These drawbacks have been overcome in the present invention and the result is a low cost system of stereoscopic photography consisting of a camera lens attachment, software for reformatting the stereo-pair so that it may be displayed on a computer screen, and a selection device for viewing the images. The present invention thus provides a viable low-cost alternative to conventional stereoscopic cameras.

### SUMMARY OF THE INVENTION

The present invention is a method and apparatus for creating and displaying stereoscopic photographs utilizing digital camera technology, although standard photographs may be scanned and digitized to achieve a similar result.

The camera has a photosensitive material, such as an electronic photosensor, optically aligned with the lens for capturing images. The camera has a liquid crystal viewfinder screen for immediate viewing of the images captured on the photosensitive material. There is also a zoom control for adjusting the focal length of the lens.

In accord with the invention, an optical attachment is securely coupled to the camera lens in a manner that permits adjustment. A typical lens includes a mounting ring for adding filters or the like, and the optical attachment can be readily made to fit this standard attachment means. The optical attachment causes a stereo pair of images to be focused through the lens onto the photosensitive material. Preferably, a Wheatstone-type stereoscope is used as the optical attachment.

The optical attachment is aligned by rotating the attachment on the mounting ring until the images are not skewed. This can be observed to occur when a boundary line between the pair of stereo images is parallel to an edge of the viewfinder screen. The focal length of the optical attachment as coupled to the lens is adjusted by operating the zoom control until the stereo pair of images completely fills the viewfinder screen.

The camera is coupled to a processor having a first program for digitizing the stereo pair of images and a second program for transforming the digitized stereo pair of images into a predefined format. The transformed images are displayed on a monitor and observed through either a modulating overlay screen or modulating eyewear.

### BRIEF DESCRIPTION OF THE DRAWINGS

FIG. 1 is a schematic drawing of a prior art camera attachment based on the Wheatstone stereoscope. It also serves to illustrate an aspect of the present invention.

FIGS. 2A-2F show various arrangements for image formats used in prior art attachments.

FIG. 3 is a system diagram of the image capture, formatting, and display of the present invention.

FIG. 4 shows how the topological transformation from the capture to display format takes place.

### DETAILED DESCRIPTION OF THE INVENTION

The present invention takes advantage of the growing popularity of the digital still camera. In the past few years, digital still photography has become increasingly important. Improvements have been made in solid-state sensors and storage technology in terms of both quality and cost reduction. These cameras are becoming commodity products, built out of lenses, sensors, and memory components made in various factories and repackaged by other manufacturers. Some of these manufactures have been known for still cameras based on silver photography technology, others for video cameras, and others for computer hardware. As digital still cameras improve in terms of resolution, there is the opportunity to use these cameras with stereoscopic attachments of the kind described here. Most importantly, practically all of the problems inherent in the prior art evaporate with the use of modern digital equipment.

Many people who take pictures with digital still cameras use their personal computers for displaying these images. The computer and its display screen are not only means for viewing the image but for correcting the color balance, contrast, density and other features of the digital image. The computer, with proper software, becomes a digital darkroom far more powerful than the traditional chemical darkroom.

Most of the development work for the present invention was done using the Camedia C-2000 Z camera made by the Olympus Camera Company. However, the optical attachment was also tried on a number of different digital cameras with similar success. Therefore, it is contemplated that the inventive concept can be generally applied to any digital camera.

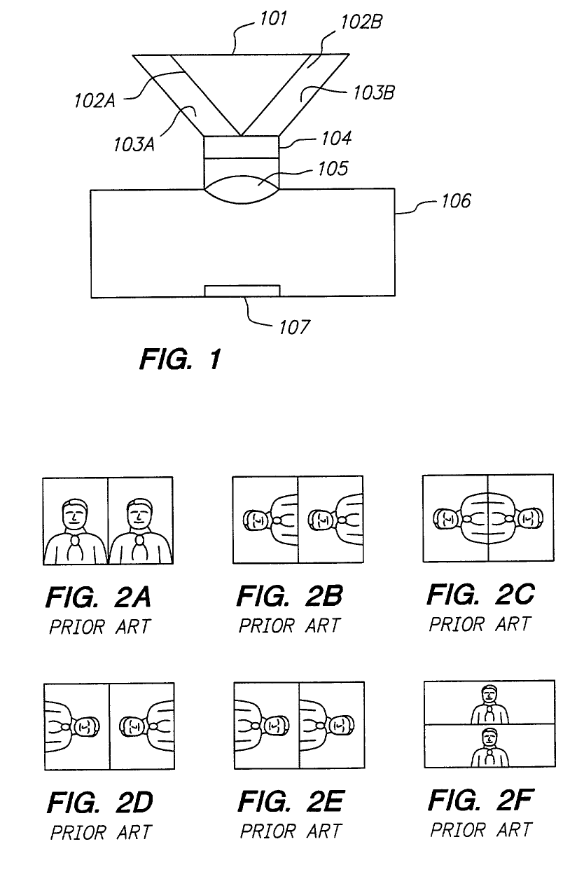

The optical attachment 101 is shown in FIG. 1, and is a design derived from the Wheatstone stereoscope and optically suited for producing the format shown in FIG. 2A, which is an ideal format for taking portraits of people. The Wheatstone stereoscope variant is attached to the camera by means of its off-the-shelf adapter 104, which is ordinarily meant for the addition of a focal lenses The optical attachment 101 is then aligned by observing the liquid crystal display screen on the camera. Liquid crystal displays, typically just an inch or two across, are an integral part of the majority of digital still cameras and provide a wonderful way for the user to preview the image. It is these liquid crystal display screens, to some significant extent, that make the present invention viable.

As explained above, it is necessary to align or “level” the optical attachment 101 so that the boundary line between the sub-frames (see FIG. 2) is parallel with one of the edges of the format. By rotating the attachment and viewing the image on the liquid crystal screen at the back of the camera, it is possible to successfully “eyeball” the alignment. If desired, the camera can be placed on a tripod or a table or desktop to aid in the procedure. The attachment is rotated in its retaining ring, and once alignment is achieved, a setscrew arrangement is used to lock the attachment in place. Once aligned, the combination of attachment and retaining ring can be screwed back on to the camera lens and tweaked into place each time it is added. Such techniques are well known to photographers, and specific means for doing so are also addressed in the patents cited in Appendix A. The proper alignment of the attachment will produce sub-frames which are not skewed, as shown in FIG. 2A. However, there is a second chance to correct a skewed image, as we shall see, by using computer photo enhancing or stereo formatting software, as described below.

One additional alignment step is required, and that is selecting the appropriate focal length to match the optical requirements of the attachment. An attachment can be inconveniently large if designed for use with wide-angle lenses because the size of the reflecting surfaces required must take in to account the lens'angle of view. To keep the size of the attachment in hand, it is best if it is designed to work with a “normal” focal length (about the length of the diagonal of the sensor). Thus it is necessary to adjust the zoom lens' focal length to work in conjunction with the attachment. The point-and-shoot digital cameras often offer zoom lenses of 2- or 3-to-1 focal length ratio—from a mild wide angle to a mild telephoto. In the middle of the zoom range, there is a range of focal lengths that are optimal for use with an attachment of convenient size. The user can do this by looking at the liquid crystal screen at is the rear of the camera and by zooming the lens so that sub-frames can be seen to properly fill the display—hence the sensor area. Once this has been accomplished the user is ready to take pictures.

After the attachment is adjusted and aligned, photography may commence. No further alignment is necessary during a picture-taking session. The camera plus attachment is as shown in FIG. 1, which serves as a schematic representation of both prior art and digital cameras because they are functionally identical. The only change is that element 107, in the case of the prior art, is a conventional photographic film; but in the present invention, it is a digital imaging sensor. Once the image has been captured, it is then transferred to a computer, and the computer is used to reformat the image, as will be described.

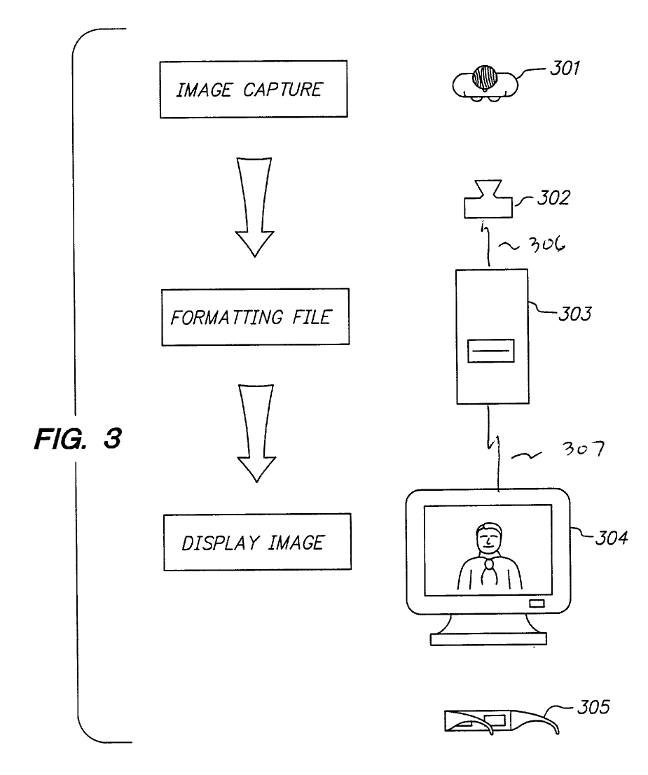

FIG. 3 charts the flow from image capture or photography with the camera, to formatting the file using computer techniques, and finally to displaying the image on a computer monitor. 301 is the subject, 302 is the digital camera 106 with optical attachment 101, 303 is the computer, 304 is the monitor with a display screen, and 305 is the stereoscopic selection device, such as occluding eyewear.

In the prior art, the need to design a stereoscope or projection attachment to work in conjunction with the camera attachment was a major design challenge and an inhibiting factor in the acceptance of the medium. What was a serious problem for silver-based photography yields to the elegance of digital-based photography and the personal computer. Indeed, during the last two decades a growing number of users in several fields have been looking at stereoscopic images on computer screens.

The display means of choice is occlusion, or field-sequential technology. The technology has proven itself for the visualization of complex data, and it can be applied to the display of digital photography as described here. Selection device products like CrystalEyes® stereoscopic eyewear and the ZScreen® flat-panel overlay, marketed by StereoGraphics Corporation, are widely accepted in the fields of molecular modeling, aerial mapping, engineering, medicine, and mechanical computer-aided design.

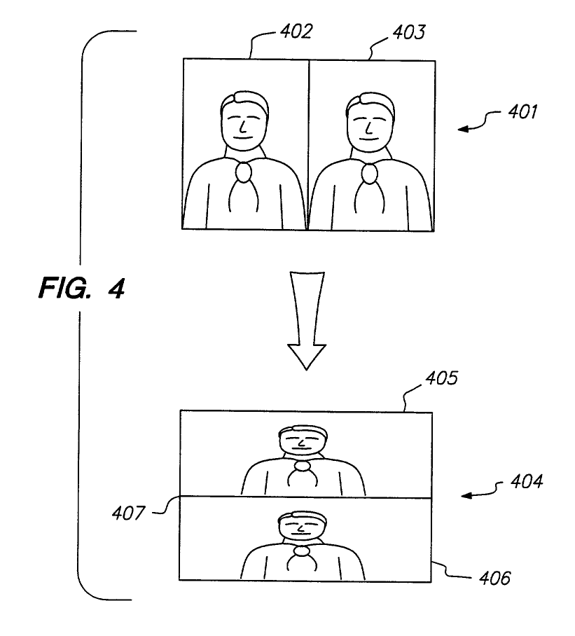

One of the most important contributions of StereoGraphics Corporation has been the art taught in U.S. Pat. No. 4,523,226, which is expressly incorporated herein by reference. This technology enables just about any modern PC and CRT monitor to display occlusion based stereoscopic images. The technique taught in the '226 patent is known as the above-and-below format and is illustrated in FIG. 4 as 404. The above-and-below format consists of two vertically anamorphically squeezed sub-fields 405 and 406 that contain the two perspective viewpoints. These sub-fields are separated by sub-field blanking area 407. When images are prepared this way and played back with a non-stereo-ready video accelerator card—that is, a video card which is not capable of running at a high field rate—the images are formatted so that they can be displayed at a high field rate. Since most video cards are not capable of running a stereoscopic image in a flicker-free mode, this is an important step.

Once images are prepared in the above-and-below format, when played on a video card running at (for example) 60 fields per second, they will appear as anamorphically squeezed above-and-below images as shown in FIG. 4. These spatially juxtaposed images become temporally juxtaposed by means of inserting a synchronization signal in the vertical blanking area 407 when played back on a monitor capable of running at a high enough field rate (at 120 fields per second in this case). Thus, spatially juxtaposed sub-fields 405 and 406 become temporally juxtaposed and can be viewed with occluding eyewear of the kind mentioned above.

In FIG. 3, after image capture of the subject 301 by camera 302, picture files are loaded onto computer 303 by means that are well known, for example via communications link 306 and appropriate software. FIG. 4 shows side-by-side left and right perspectives 402 and 403, which cannot be viewed stereoscopically using the occluding system discussed above. Thus, these side-by-side images must be reformatted into the above-and-below format 404, as discussed above and in the '226 patent, to be displayed in the flicker-free mode.

As is understood by ordinary users and practitioners of the art of computer graphics, this kind of a topological transformation is a routine operation. The process can be readily carried out using a suitable software program such as Adobe PhotoShop and similar variants which permit the shapes of images to be changed at will. A particularly useful program for this task is Sudden Depth marketed by Chasm Graphics. With just a few keystrokes or a few clicks of the mouse, the side-by-side format 401 can be converted into the above-and-below format 404 and then transferred via communications link 307 to monitor 304 for viewing with eyewear 305.

After image reformatting, the user has an opportunity to optimize the stereoscopic image using suitable software. For example, Sudden Depth allows for this kind of manipulation. The left and right sub-fields can be shifted vertically or horizontally with respect to each other, and by this means vertical parallax (if any) can be eliminated, and the location of the “stereo-window” can be set.

In order to simplify the description of the invention, I have chosen a specific example of a camera attachment (Wheatstone) and format (side-by side), and a specific display format (above-and-below). However, the reader skilled in the art will understand that this specificity has been used for didactic purposes, and that any of the formats shown in FIG. 2 could serve as a suitable basis as well for practicing the invention. In other words, any of these formats may be topologically transformed, by means of a software process, into a more useful display format. The idea is that such a process may alter the format that is produced by any camera attachment. The optics of the attachment will dictate a specific format that may well be unsuited to the needs of display. It is the task of the formatting step to turn the sub-frames into a format suitable for display using the occlusion system.

A person skilled in the art will also recognize that there are other formats for displaying the images using a computer, display screen, and occluding eyewear I have chosen the above-and-below technique specifically, not only because I believe it to be the most important display means, but as a didactic device to aid in the understanding of the concept in general. The above-and-below format is one means amongst many. In addition, the interlace method (and its variants) serve as well. Moreover, video boards that are stereo ready—those working at an intrinsically high field rate—can also display such images. In all such cases, the formatting step shown in FIG. 3, accomplished with computer 303, remains in place, only the specific format required for display is chosen to match the characteristics of the video accelerator board in the computer.

Further, one skilled in the art will recognize that the occlusion technique itself, while it is expected to be the predominant display means, is not the only one that may be practiced. The occlusion technique depends upon a sequence of fields, but there are other techniques that depend upon a sequence of pixels, such as the micropol or interdigitated stereogram techniques—the latter usually using either a lenticular screen or a raster barrier for selection devices. In these cases it is a relatively trivial task to create the format best suited to the display means from the camera attachment created sub-frames.

It should also be understood from looking at FIG. 1 that, although not optimal, a traditional film-based camera could be used. The images can then be photographed as either a negative or a transparency, and these images can be turned into digital picture files by a scanning device. The process presented above for manipulating the image and turning it into a field-sequential format is then applied.

APPENDIX A

| U.S. Pat. No. | Issued | Inventor |
|---|---|---|
| 1,071,837 | 10/1913 | Wayditch |
| 1,282,073 | 10/1918 | Hahn |
| 1,307,074 | 06/1919 | Baruch |
| 1,929,685 | 10/1933 | Feil |
| 2,135,049 | 11/1938 | Harvey |
| 2,146,135 | 02/1939 | Adams et al. |
| 2,240,398 | 04/1941 | Huitt |
| 2,268,712 | 01/1942 | Luer et al. |
| 2,282,947 | 05/1942 | De Sherbinin |
| 2,303,742 | 12/1942 | Howells |
| 2,313,561 | 03/1943 | Mainardi et al. |
| 2,314,174 | 03/1943 | Steinman |
| 2,317,875 | 04/1943 | Athey et al. |
| 2,321,894 | 05/1943 | Bischoff |
| 2,348,410 | 05/1944 | Pastor |
| 2,362,790 | 11/1944 | Austin |
| 2,403,733 | 07/1946 | Mainardi et al. |
| 2,413,996 | 01/1947 | Ramsdell |
| 2,495,288 | 01/1950 | Richards |
| 2,568,327 | 09/1951 | Dudley |
| 2,627,201 | 02/1953 | Baker |
| 2,669,902 | 02/1954 | Barnes |
| 2,693,128 | 11/1954 | Dewhurst |
| 2,716,920 | 09/1955 | Rosier |
| 2,724,311 | 11/1955 | Albert |
| 2,736,250 | 02/1956 | Papritz |
| 2,784,645 | 03/1957 | Grey |
| 2,991,690 | 07/1961 | Grey et al. |
| 3,160,889 | 12/1964 | Giacometti |
| 3,254,933 | 06/1966 | Latulippe |
| 3,551,036 | 12/1970 | Bielusici |
| 3,674,339 | 07/1972 | Sayanagi |
| 3,846,810 | 11/1974 | Ihms |
| 3,891,313 | 06/1975 | Murphy |
| 4,009,951 | 03/1977 | Ihms |

I claim:

1. A stereoscopic photography method, comprising:
providing a camera having a lens for focusing an image and a photosensitive material optically aligned with the lens for capturing the image;
securely coupling an optical attachment to the camera lens, said optical attachment being adapted to cause a stereo pair of images to be focused through the lens onto the photosensitive material;
digitizing the stereo pair of images which are captured on the photosensitive material;
transforming the digitized stereo pair of images into a predefined display format; and
displaying the transformed images on a stereoscopic display system that utilizes the predefined display format.

2. A stereoscopic photography method according to claim 1, further comprising aligning the optical attachment to the lens before the secure coupling step.

3. A stereoscopic photography method according to claim 2, wherein the camera further comprises a viewfinder screen for viewing images captured on the photosensitive material, and wherein the alignment step comprises rotating the optical attachment on its lens coupling until a boundary between the stereo pair of images is parallel with an edge of the viewfinder screen.

4. A stereoscopic photography method according to claim 1, further comprising optimizing the focal length of the optical attachment coupled to the lens.

5. A stereoscopic photography method according to claim 4, wherein the camera further comprises a viewfinder screen for viewing images captured on the photosensitive material and a zoom control, and wherein the optimizing step comprises operating the zoom control until the stereo pair of images fills the viewfinder screen.

6. A system for stereoscopic photography, comprising:
a camera having a lens for focusing an image and a photosensitive material optically aligned with the lens for capturing the image;
an optical attachment adjustably coupled to the camera lens, said optical attachment being adapted to cause a stereo pair of images to be focused through the lens onto the photosensitive material;
a processor having a first program for digitizing the stereo pair of images which are captured on the photosensitive material a second program for transforming the digitized stereo pair of images into a predefined format; and
a monitor for displaying the transformed images.

7. A system for stereoscopic photography as in claim 6, further comprising a modulating overlay panel coupled to the monitor for selectively and alternately transmitting therethrough a first image then a second image of the stereo pair of images.

8. A system for stereoscopic photography as in claim 6, further comprising a modulating pair of eyewear for observing the monitor and selectively and alternately transmitting therethrough a first image then a second images of the stereo pair of images.

9. A system for stereoscopic photography as in claim 6, wherein the camera is a digital camera.

10. A system for stereoscopic photography as in claim 9, wherein the digital camera further comprises a viewfinder screen for viewing images captured on the photosensitive material, and wherein the optical attachment is manually aligned before being secured to the camera by rotating the optical attachment on its lens coupling until a boundary between the stereo pair of images is parallel with an edge of the viewfinder screen.

11. A system for stereoscopic photography as in claim 9, wherein the digital camera further comprises a viewfinder screen for viewing images captured on the photosensitive material a zoom control, and wherein the focal length of the optical attachment coupled to the lens is optimized by operating the zoom control until the stereo pair of images fills the viewfinder screen.

12. A system for stereoscopic photography as in claim 6, wherein the camera is an autoreflex camera and the photosensitive material is film.

13. A system for stereoscopic photography as in claim 12, wherein negatives are developed from the film and then scanned for digitizing in the processor.

14. A system for stereoscopic photography as in claim 6, wherein the optical attachment is a Wheatstone-type stereoscope.

15. A system for stereoscopic photography, comprising:
a digital camera having a lens for focusing an image, a photosensitive material optically aligned with the lens for capturing the image, a viewfinder screen for viewing images captured on the photosensitive material and a zoom control for adjusting the focal length of the lens;
an optical attachment adjustably coupled to the camera lens, said optical attachment being adapted to cause a stereo pair of images to be focused through the lens onto the photosensitive material;
a processor coupled to the camera and having a first program for digitizing the stereo pair of images which are captured on the photosensitive material and a second program for transforming the digitized stereo pair of images into a predefined format; and
a monitor coupled to the processor for displaying the transformed images.

16. A system for stereoscopic photography as in claim 15, further comprising a modulating overlay panel coupled to the monitor for selectively and alternately transmitting therethrough a first image then a second image of the stereo pair of images.

17. A system for stereoscopic photography as in claim 15, further comprising a modulating pair of eyewear for observing the monitor and selectively and alternately transmitting therethrough a first image then a second images of the stereo pair of images.
